(19) United States
(12) Patent Application Publication
(10) Pub. No.: US 2006/0185480 A1
(43) Pub. Date: Aug. 24, 2006

(54) Fastener driver

(76) Inventor: William Stanley Myskowski, Sinking Spring, PA (US)

Correspondence Address: William S. Myskowski, 1016 Baker Road, Sinking Spring, PA, 19608, US

(21) Appl. No.: 11/029,858

(22) Filed: Jan. 6, 2005

(51) Int. Cl. B25B 15/00

(52) U.S. Cl. 81/436

(57) ABSTRACT

The Fastener Driver is a tool which is specifically designed to install the common sense fastener. The Fastener Driver tool comprises one end, which is specifically shaped so that the top of the common sense fastener can be inserted and locked into place, and the other end, which is solid steel for insertion into a rotary drill. The top of the common sense fastener is inserted into the specifically shaped end of the tool and the solid steel end of the tool is inserted into a drill. Then a rotary drill is used to power the installation of the common sense fastener into any material. Using the Fastener Driver with a rotary drill decreases the installation time of the common sense fastener by at least 50% and considerably reduces the manual labor and exertion over the current manual method of installation.

### CROSS REFERENCE TO RELATED APPLICATIONS

U.S. Pat. No. 2,725,770 Dec. 1955 Short Harold O, et. al. 81/475

### STATEMENT OF FEDERALLY SPONSORED RESEARCH/DEVELOPMENT

None.

### REFERENCE TO SEQUENCE LIST

None.

### BACKGROUND OF THE INVENTION

a. Field of the Invention

This invention relates to tools which are used to install fasteners into a variety of materials using a rotary drill as power, and more particularly to a tool to be powered by a rotary drill for installing the common sense fastener into a variety of materials and surfaces.

b. Description of the Prior Art

There are a variety of tools which can be inserted into a rotary drill for the installation of screws, nails and fasteners used to adhere materials. One type of fastener, which is used to attach awnings, canvas and other materials to a variety of surfaces, is called the common sense fastener. The common sense fastener is unique in design in that the fastener has a turnbuckle on the top of the fastener, a screw on the bottom of the fastener and a uniquely shaped solid body which holds both the turnbuckle and the screw.

In the prior art, the common sense fastener is manually installed into a surface by placing the thumb and finger on the turnbuckle top and exerting manual force to turn the top so that the screw is fully inserted into the surface. To attach a canvas to a boat or an awning to a house, one will manually install many common sense fasteners in the material, requiring not only a significant amount of time but also considerable manual labor and force. After installation of all the common sense fasteners, the canvas or awning is attached to each installed fastener and the canvas or awning is secured by turning the turnbuckle top of the common sense fastener in a perpendicular direction.

Considering the number of common sense fasteners that are needed for a single installation and the number of installations of canvas, awning and related materials that are done in the United States and around the world, there is a definite need for an improved method to decrease the manual time, force and labor required for the installation of the common sense fasteners.

### SUMMARY OF THE INVENTION

The object of this invention is to provide a means to decrease the manual time and the manual force and labor involved in installing common sense fasteners to surfaces in a variety of applications involving canvas, awnings and other materials.

A further object of this invention is to be able to use a common, widely used piece of equipment, a rotary drill, to power the invention and therefore make the invention available to a wide base of operators with minimal instruction or training.

These objects and other objects are accomplished by the development of a tool which has a uniquely designed and shaped end which holds the common sense fastener firmly and securely. The tool has another cylindrical end which is made of solid steel and can be inserted easily and securely into a rotary drill. With the power of the drill and the use of Fastener Driver tool, the common sense fastener can be installed with minimal manual effort and exertion and can be installed in at least 50% of the time required by the prior manual method. Manual force is greatly decreased by using the tool since the exertion required to install the fastener is provided by a rotary drill.

After installation of the fastener into the surface, the tool can be easily released from the common sense fastener. The tool can also be easily released from the chuck of a rotary drill.

### BRIEF DESCRIPTION OF THE DRAWINGS AND PHOTOGRAPHS

FIG. 1 is a drawing of the tool depicting the detail parts.

FIG. 2 is a view of the tool with the common sense fastener at the end in which it is inserted. This view shows the turnbuckle top, the unique shape of body of the fastener and the screw on the bottom of the fastener. This view also shows the unique shape of the molded end of the tool into which the fastener is inserted.

FIG. 3 is a view of the tool with the common sense fastener inserted. This view shows that the tool covers the turnbuckle of the fastener and snugly and securely fits the body of the fastener to hold the fastener firmly in place.

FIG. 4 is a view of the tool with the common sense fastener inserted in the uniquely shaped end and the solid cylindrical end of the tool inserted into the chuck of a rotary drill. This view shows how the two ends of the tool are used to install the common sense fastener with the cylindrical hollow body of the tool acting as a long, sturdy holder for driving the fastener into a surface.

### DETAILED DESCRIPTION OF THE INVENTION

Detailed embodiments of the present invention are disclosed in the following information, however, these descriptions and specific structural and functional details are merely exemplary of the invention and not intended to be limiting.

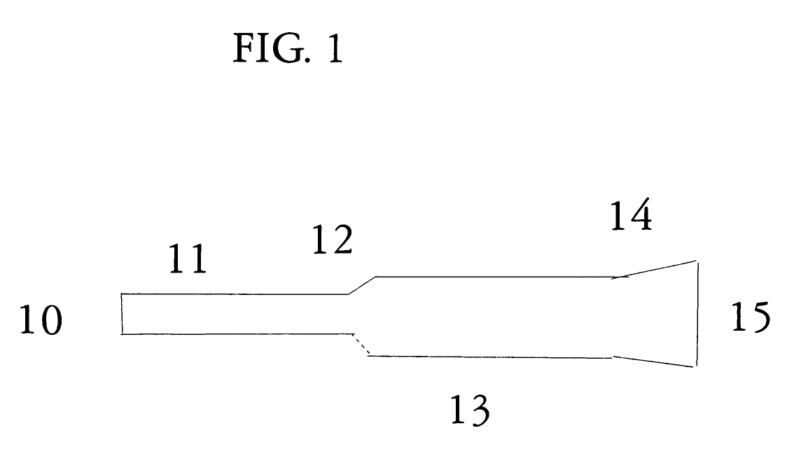

As seen in FIG. 1, the tool end 10 is a solid steel cylindrical end which is designed to fit snugly and securely into the drill chuck of a rotary drill. The solid steel cylinder 11 in FIG. 1 serves as the part of the tool which adds strength to the tool when it is inserted into a rotary drill.

The weld 12 in FIG. 1 is made to connect the solid steel cylinder 11 to the hollow cylindrical body 13. The weld 12 is made of brass or a material of sufficient strength to provide a strong connection for the solid steel cylinder 11 and the hollow steel cylindrical body 13.

The hollow steel cylinder 13 shown in FIG. 1 serves as the body of the tool. The cylinder 13 provides the body for forming the uniquely molded shape 14 and also provides a strong holder for the operator during the fastener installation. A uniquely molded shape 14 in FIG. 1 is specifically designed to the shape of the common sense fastener to cover the turnbuckle and to fit firmly and securely on the body of the common sense fastener.

As shown in FIG. 1 the end 15 is the position at which the common sense fastener is inserted. The end 15 is designed to provide a firm and secure connection with the common sense fastener. The end 15, along with the cylinder 13, also provides a means for easy release of the fastener by the operator following the installation of the fastener.

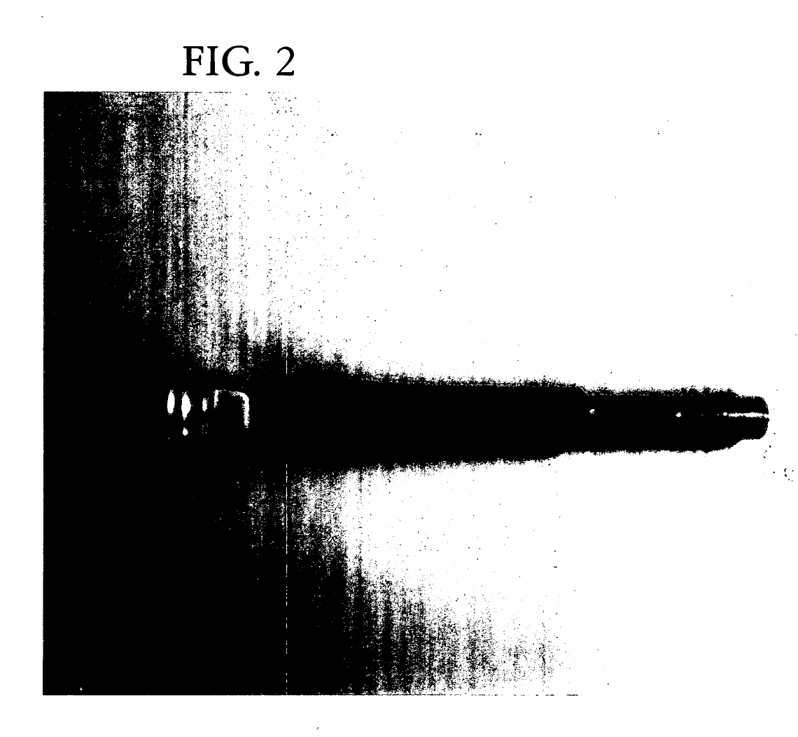

As depicted in FIG. 2, the common sense fastener has a unique turnbuckle top which is used to manually install the fastener into material in the current art. FIG. 2 shows the tool end 15, as described in FIG. 1, where the common sense fastener will be inserted in the tool. The unique top of the common sense fastener fits securely into the uniquely molded shape 14 in FIG. 1 and the tool end 15 in FIG. 1 snaps firmly and securely to the body of the common sense fastener.

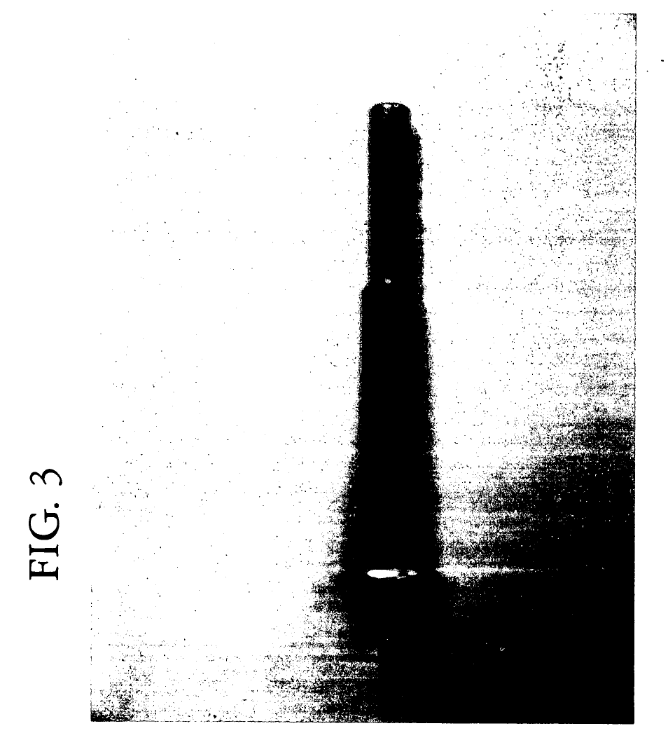

The common sense fastener is inserted in FIG. 3. This view depicts that the uniquely shaped end of the tool covers the turnbuckle and fits perfectly to the body of the common sense fastener.

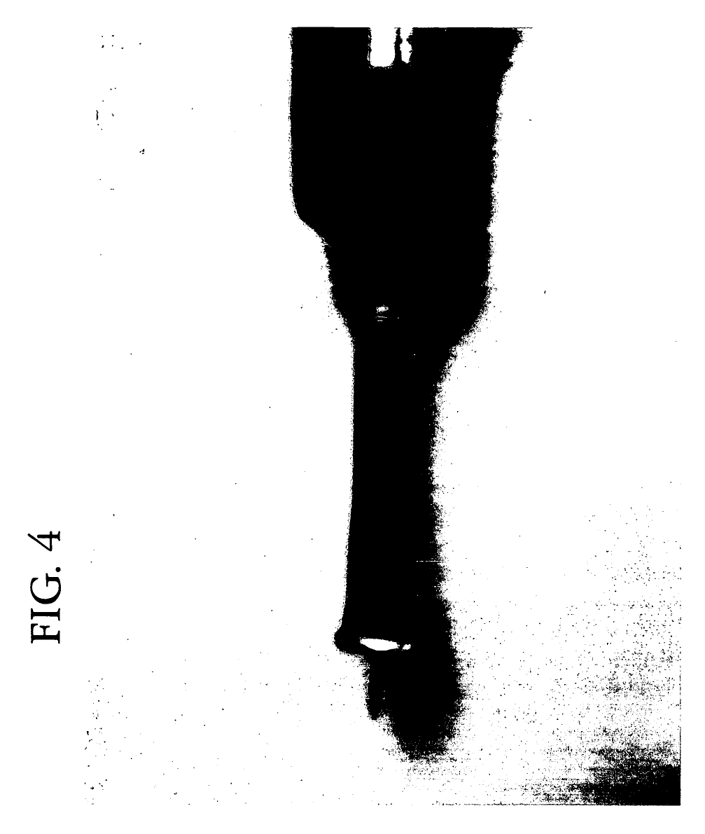

As depicted in FIG. 4, the tool is inserted into the drill bit end of a rotary drill which is used to power the installation of the common sense fastener into the material. FIG. 4 shows how the solid cylindrical end, described in FIG. 1 end 10, fits perfectly into the drill bit and the solid steel cylinder, described in FIG. 1 cylinder 11, provides a strong connection with a rotary drill.

The hollow cylindrical body, described in FIG. 1 cylinder 13, provides a strong holder for the operator during the fastener installation process.

As indicated by FIG. 4, the tool, powered by a rotary drill, greatly reduces the time, manual labor and manual force involved in the current method of installing the common sense fasteners.

Various changes, modifications and alternatives will become obvious to a person of ordinary skill in the art in view of the foregoing specification. Accordingly, it is intended that all such changes, modifications and alternatives as come within the scope of the stated claims be considered as part of this invention.

### SEQUENCE LISTING

None.

I claim:

1. A tool designed specifically to facilitate the installation of the common sense fastener into any material or surface, said tool comprising:
a) one end, which is a solid steel cylindrical drive shaft and welded with brass, or a material of sufficient strength, into the tubular body of the tool, to be inserted into the chuck of a rotary drill
b) the tubular body, which is hollow steel, is welded to the solid steel cylindrical drive shaft and forms the extension for the common sense fastener molded end
c) the common sense fastener molded end, which is an extension of the tubular body, is specifically shaped and formed to the configuration of the turnbuckle top and the body of the common sense fastener
d) the shaped and molded end holds the common sense fastener firmly and securely in place when a rotary drill is used to power the installation of the common sense fastener into any material or surface
e) the tubular body provides support for the operator during the installation of the fastener into the surface
f) the tubular body provides support to easily release the installed fastener from the tool
g) the solid steel cylindrical drive shaft fits firmly and securely into the drill chuck of a rotary drill and keeps the tool securely in the drill chuck until the tool is released from the drill chuck by the operator.
